(19) United States
(12) Patent Application Publication
(10) Pub. No.: US 2011/0133491 A1
(43) Pub. Date: Jun. 9, 2011

(54) VEHICLE DOOR LATCH

(76) Inventors: Donald M. Perkins, Sterling Heights, MI (US); Francisco J. Lujan, Juarez (MX); Carlos I. Tostado, Juarez (MX)

(21) Appl. No.: 12/633,479

(22) Filed: Dec. 8, 2009

(51) Int. Cl. E05C 3/06

(52) U.S. Cl. 292/216

(57) ABSTRACT

A vehicle door latch assembly is disclosed herein, the vehicle door latch having: a forkbolt movably secured to the latch assembly, the forkbolt being capable of movement between a latched position and an unlatched position; a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt; and an anti-bypass member secured to the latch assembly, the anti-bypass member being configured to prevent the engagement surface of the detent lever from being deflected away from the engagement surface of the forkbolt when the detent lever is in the engaged position and the forkbolt is in the latched position such that the forkbolt would be able to move to the unlatched position when the detent lever is in the engaged position.

### BACKGROUND

Exemplary embodiments of the present invention relate to door and movable panel latches and, more particularly, to door and movable panel latches for vehicles.

A vehicle frequently includes displaceable panels such as doors, hood, trunk lid, hatch and the like which are affixed for hinged or sliding engagement with a host vehicle body. Cooperating systems of latches and strikers are typically provided to ensure that such panels remain secured in their fully closed position when the panel is closed.

A door latch typically includes a forkbolt that is pivoted between an unlatched position and a primary latched position when the door is closed to latch the door in the closed position. The forkbolt is typically held in the primary latched position by a detent lever that pivots between an engaged position and a disengaged position. The detent lever holds the forkbolt in the primary latched position when in the engaged position and releases the forkbolt when in the disengaged position so that the door can be opened.

The forkbolt is pivoted to the primary latched position by a striker attached to, for example, an associated door jamb when the door is closed. Once in the primary latched position, the detent lever engages the forkbolt to ensure the assembly remains latched.

Today's passenger vehicles are subjected to ever increasing government impact specifications. Therefore the structural integrity of the overall vehicle is of the highest scrutiny by all manufacturers. Crashworthiness extends to all subsystems of the vehicle. One such subsystem is the door to body interface as controlled by the side door latch and striker system. This system is required to remain intact throughout crash events.

The door latch and striker interface, during a side intrusion crash condition, can experience gross deformation from its designed geometry. Since conventional vehicle door construction places the door latch within the door cavity, the surface to which the door latch is mounted undergoes the same gross deformation. This mounting surface deformation coupled with the radical deformation to the striker to door latch relationship creates a condition within the door latch referred to as planar bypass.

When the vehicle door is closed, the door latch first contacts the striker through the forkbolt lever, rotating it to a closed position. When rotated to this closed position, a second lever, the detent lever, operating in the same planar relationship to the forkbolt lever, rotates into position impeding the anti-rotation of the forkbolt, thus latching the door. The surface at which these two levers interface may be referred to as the bite surface. These two levers are usually sandwiched between a steel structural frame plate and a plastic housing, and each pivot upon their respective steel pivots which are held fixed to the steel frame plate. In most instances, the steel pivots are dual supported at the opposite end with an additional structural plate, heretofore referred to as a backplate.

In a side impact event, or other condition that creates deformation of the door latch mounting surface, the relationship between the frame plate, steel pivots and backplate can be altered in such a manner as to create an out of plane movement between the detent lever and the forkbolt lever. If this movement reaches a point where the detent lever no longer engages the forkbolt, or a point where the contact surface is not adequate enough to withstand the loading conditions, the forkbolt lever can slide under or over the detent lever contact surface, thus creating a bypass condition.

Accordingly, it is desirable to provide a vehicle latch assembly that prevents the forkbolt lever from sliding under or over the detent lever contact surface.

### SUMMARY OF THE INVENTION

In accordance with an exemplary embodiment of the invention, a vehicle latch assembly is provided. The latch assembly having: a forkbolt movably secured to the latch assembly, the forkbolt being capable of movement between a latched position and an unlatched position; a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt; and an anti-bypass member secured to the latch assembly, the anti-bypass member being configured to prevent the engagement surface of the detent lever from being deflected away from the engagement surface of the forkbolt when the detent lever is in the engaged position and the forkbolt is in the latched position such that the forkbolt would be able to move to the unlatched position when the detent lever is in the engaged position.

In accordance with another exemplary embodiment of the present invention, a method of preventing a forkbolt of a vehicle door latch assembly from moving into an unlatched position when a detent lever of the vehicle door latch assembly is in an engaged position is provided, the method comprising: pivotally securing the forkbolt to the vehicle door latch assembly for movement in a first plane between the unlatched position and a latched position; pivotally securing the detent lever to the vehicle door latch assembly for movement in the first plane between the engaged position and a disengaged position wherein a contact surface of the detent lever engages a contact surface of the forkbolt when the detent lever is in the engaged position and the forkbolt is in the latched position; and preventing the forkbolt or the detent lever from moving in a direction other than the first plane such that the forkbolt can move from the latched position to the unlatched position when the detent lever is in the engaged position.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a perspective view illustrating a latch assembly in a closed or primary latched position in accordance with an exemplary embodiment of the present invention;

FIG. 2 is another perspective view of the latch assembly of FIG. 1 with a back plate;

FIGS. 3A-3B are views illustrating deformation of a latch assembly;

FIGS. 4 and 5 are views illustrating the detent lever and forkbolt interface;

FIGS. 6 and 7 are views illustrating an exemplary embodiment of the present invention; and

FIGS. 8A-8B are views illustrating deformation of a latch assembly in accordance with an exemplary embodiment of the present invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to an apparatus and method for providing a latch assembly. Furthermore, exemplary embodiments are directed to a latch assembly having a forkbolt or forkbolt lever movably secured thereto for movement between a latched position and an unlatched position. The latch assembly further comprises a detent lever capable of movement between an engaged position and a disengaged position, wherein the detent lever retains the forkbolt in the latched position when the detent lever is in the engaged position. In accordance with an exemplary embodiment of the present invention the latch assembly is provided with an anti-bypass member configured to prevent the engagement surface of the detent lever from being deflected away from the engagement surface of the forkbolt when the detent lever is in the engaged position and the forkbolt is in the latched position such that the forkbolt would be able to move to the unlatched position when the detent lever is in the engaged position.

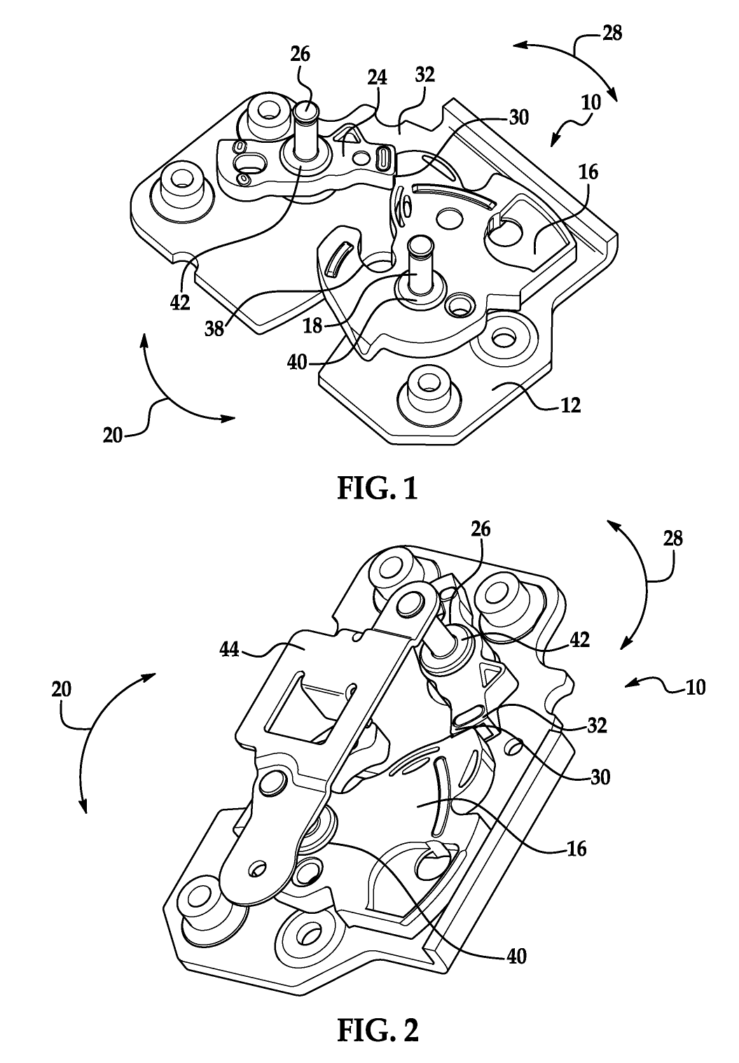

Referring now to FIGS. 1-2 and 4-8B a vehicle compartment latch or latch assembly 10 in accordance with an exemplary embodiment of the present invention is illustrated. In one embodiment, vehicle compartment latch 10 comprises a frame plate or support 12 that is adapted for fastening to a vehicle proximate to a compartment closure.

Reference is made the following U.S. Pat. Nos. 6,811,193; 7,090,264; 5,520,426; 5,277,461; 5,316,354; 5,454,608; 4,969,673; 5,715,713; 5,535,607; 6,264,253; 6,749,234; and 6,733,052 the contents each of which are incorporated herein by reference thereto.

A forkbolt or forkbolt lever 16 is pivotally or rotationally mounted to frame plate 12 about a pivot pin or stud 18 that is received within a pivot pin opening of the forkbolt. Forkbolt 16 is capable of rotational movement between an open or unlatched position and a closed or latched position shown in FIGS. 1 and 2, wherein the forkbolt rotates in the direction of arrows 20.

Vehicle compartment latch 10 is attached to a vehicle structure such that forkbolt 16 is moved between the open position and the closed position when a door, window, lift gate, etc. is opened and closed and forkbolt 16 engages a striker 22 that is attached to the door, window, lift gate, etc. Alternatively, the vehicle compartment latch 10 is secured to the door, window, lift gate, etc. and the striker is secured to the vehicle body at an opening into which the door, window, lift gate, etc. is received. The cooperation of a forkbolt and striker is well known and need not be described in detail.

Vehicle compartment latch 10 further comprises a detent lever 24 that pivots on support or frame plate 12 about a pivot pin 26 received within a pivot pin opening in the detent lever. The detent lever cooperates with forkbolt 16 in a well known manner to retain forkbolt 16 in the closed position shown in the FIGS. or release the forkbolt 16 for return to the open position. That is, detent lever 24 pivots between a closed or engaged detent position shown in the FIGS. and a release or disengaged detent position in the direction of arrows 28. In accordance with an exemplary embodiment of the present invention, forkbolt 16 is spring biased to the open position by a biasing member (e.g., coil spring or other equivalent member) that has one end attached to forkbolt 16 and the other end attached to the housing or other equivalent location. Similarly, a biasing member or spring will also bias the detent lever in the direction of a face of forkbolt 16.

In accordance with exemplary embodiments of the present invention, the forkbolt has a surface 30 that slides along and makes contact with a complimentary surface 32 of the detent lever when the forkbolt pivots or moves from the open position to the closed position and once in the closed position surface 30 of the forkbolt engages a surface 32 of the detent lever thus engaging the forkbolt and securing it into the closed position when the striker is secured in a receiving opening 38 of the forkbolt. Once the latch is in the closed position the detent lever is spring biased into contact with the forkbolt such that the forkbolt cannot rotate into the open position unless the detent lever is moved back to the release or disengaged detent position (e.g., moving surface 30 away from surface 32 allowing the forkbolt to rotate into the open position).

FIGS. 1 and 2 show a typical configuration of a side door latch structural components in a fully latched orientation. As seen, the detent lever is engaged on the primary tooth of the forkbolt lever, and each lever is capable of rotating about its respective pivot stud. The pivot studs are held mechanically fixed to the frame plate thus trapping their respective levers between the frame plate and a formed flange 40, 42 of the pivot studs. The pivot studs are dual supported opposite the frame plate by a back plate 44.

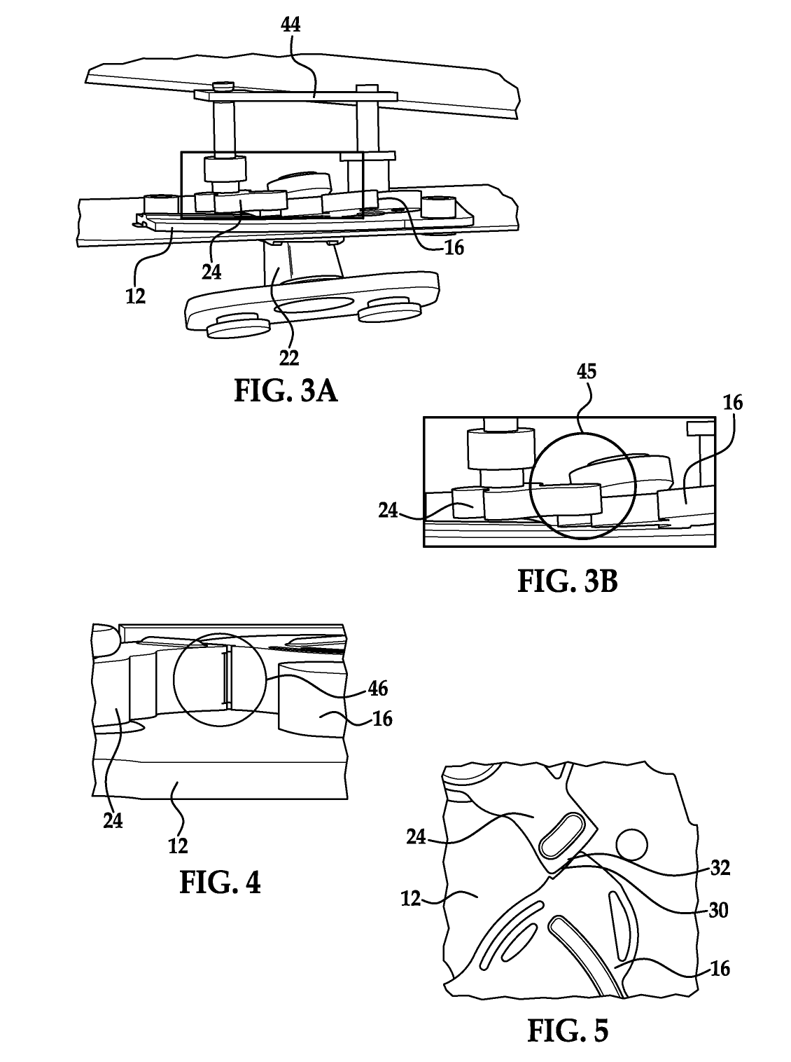

FIG. 3A shows a similar latch configuration under loading conditions (example A) which may be encountered in a side impact event where vehicle sheet metal the latch is secured to undergoes gross deformation and the latch assembly is a side vehicle latch assembly and the latch assembly is subjected to these deformation loadings. This deformation can cause the forkbolt lever and the detent lever to move out-of-plane from each other causing a partial bite condition 45 as detailed in FIG. 3B. In this partial bite condition only portions of the contact surfaces of forkbolt and the detent lever are engaging each other and may in fact slide over each other allowing the forkbolt to transition to an open position.

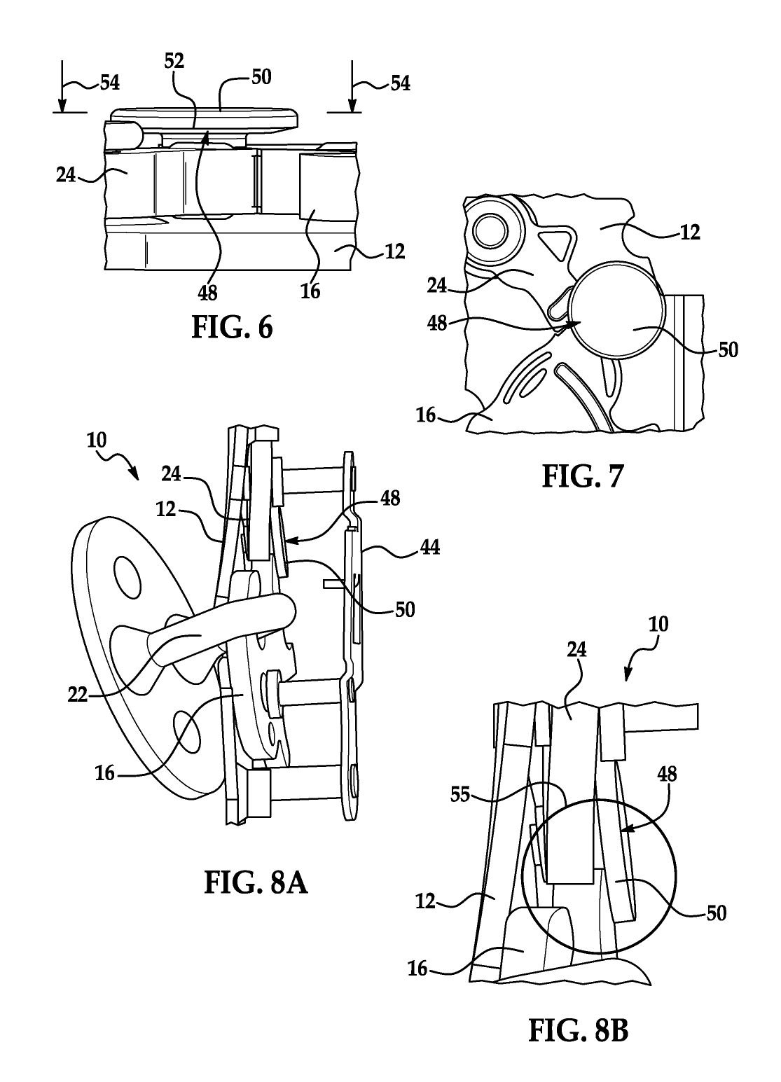

FIGS. 4 and 5 illustrate a preferred planar relationship between the forkbolt and the detent lever and a bite surface interface 46. As shown, the contact surfaces of the forkbolt and the detent lever are almost completely engaging each other. In accordance with an exemplary embodiment, FIGS. 6 and 7 illustrate a feature referred to as an anti-bypass member or an anti-bypass rivet 48. As illustrated in FIGS. 6 and 7, the anti-bypass rivet comprising a steel member or any other suitable material is secured to the latch assembly by any suitable process (e.g., press fitting, welding, etc.) and is located in such a manner so as to not impede the rotation of the forkbolt and the detent lever under normal operation.

However, the anti-bypass member or an anti-bypass rivet prevents unwanted movement of the forkbolt and/or the detent lever. In order to do this the anti-bypass member or anti-bypass rivet has a head portion 50 that depends outwardly from a shaft portion 52 of the anti-bypass member or anti-bypass rivet 48. Furthermore, the head portion of the anti-bypass member or anti-bypass rivet is located and large enough to cover the bite surface interface of the forkbolt and detent lever.

In addition, the head portion 50 of the anti-bypass member or anti-bypass rivet is located in a plane or second plane 54 that is parallel to a plane or first plane that the forkbolt and the detent lever rotate in. Accordingly, the anti-bypass member or anti-bypass rivet will allow for rotational movement of the forkbolt and the detent lever however if their movement begins to move out of the plane they rotate in the detent lever or the forkbolt or both with contact the anti-bypass member or anti-bypass rivet and preventing a by-pass condition wherein the forkbolt transitions to the open position when the detent lever is in the engaged position.

FIGS. 8A and 8B illustrate the benefit from the anti-bypass member or an anti-bypass rivet. Under the same loading conditions simulated in FIGS. 3A and 3B (example A), as illustrated relative out of plane movement between the forkbolt and the detent levers is controlled by the flange or head portion of the anti-bypass member or anti-bypass rivet thereby not allowing or reducing the opportunity of a planar bypass condition to occur. As illustrated in FIG. 8B, the bite surface area 55 is maintained through the positioning of head member 50 of the anti-bypass rivet or anti-bypass member. Accordingly and under the same loading conditions FIGS. 3A-3B vs. 8A and 8B, a lager amount of surface area of the detent lever and the forkbolt is maintained in contact (e.g., bit surface of area 45 vs. bite surface of area 55) during similar deformation loadings. Accordingly, the anti-by pass rivet or anti-by pass member prevents the forkbolt from travelling into the open position by passing over or under the detent lever when the detent lever is in the engaged position and the striker and/or the latch assembly is subject to deformation loadings such as those illustrated in FIGS. 3A-3B and 8A-8B.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A vehicle door latch assembly, comprising:
a forkbolt movably secured to the latch assembly, the forkbolt being capable of movement between a latched position and an unlatched position;
a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt; and
an anti-bypass member secured to the latch assembly, the anti-bypass member being configured to prevent the engagement surface of the detent lever from being deflected away from the engagement surface of the forkbolt when the detent lever is in the engaged position and the forkbolt is in the latched position such that the forkbolt would be able to move to the unlatched position when the detent lever is in the engaged position.

2. The vehicle door latch assembly as in claim 1, wherein the anti-bypass member is a rivet secured to the vehicle door latch assembly.

3. The vehicle door latch assembly as in claim 2, wherein the rivet is secured to a frame plate of the vehicle door latch assembly and the forkbolt and the detent lever are movably secured to the frame plate.

4. The vehicle door latch assembly as in claim 3, wherein the rivet further comprises a shaft portion and a head member, the head member being disposed over the engagement surface of the detent lever and the engagement surface of the forkbolt.

5. The vehicle door latch assembly as in claim 1, wherein the anti-bypass member is a rivet secured to the vehicle door latch assembly, the rivet having a shaft portion and a head portion depending outwardly from the shaft portion.

6. The vehicle door latch assembly as in claim 5, wherein the rivet is secured to a frame plate of the vehicle door latch assembly and the forkbolt and the detent lever are movably secured to the frame plate for pivotal movement in a first plane.

7. The vehicle door latch assembly as in claim 6, wherein the head member is disposed in a second plane, the second plane being spaced from the first plane to allow for pivotal movement of the forkbolt and the detent lever and the head member is disposed over the engagement surface of the detent lever and the engagement surface of the forkbolt.

8. The vehicle door latch assembly as in claim 7, wherein the first plane is parallel to the second plane.

9. A method of preventing a forkbolt of a vehicle door latch assembly from moving into an unlatched position when a detent lever of the vehicle door latch assembly is in an engaged position, the method comprising:
pivotally securing the forkbolt to the vehicle door latch assembly for movement in a first plane between the unlatched position and a latched position;
pivotally securing the detent lever to the vehicle door latch assembly for movement in the first plane between the engaged position and a disengaged position wherein a contact surface of the detent lever engages a contact surface of the forkbolt when the detent lever is in the engaged position and the forkbolt is in the latched position; and
preventing the forkbolt or the detent lever from moving in a direction other than the first plane such that the forkbolt can move from the latched position to the unlatched position when the detent lever is in the engaged position.

10. The method of claim 9, wherein movement of the forkbolt or the detent in the direction other than the first plane is prevented by an anti-bypass member secured to the latch assembly, the anti-bypass member being configured to prevent the engagement surface of the detent lever from being deflected away from the engagement surface of the forkbolt when the detent lever is in the engaged position and the forkbolt is in the latched position such that the forkbolt would be able to move to the unlatched position when the detent lever is in the engaged position.

11. The method as in claim 10, wherein the anti-bypass member is a rivet secured to the vehicle door latch assembly.

12. The method as in claim 11, wherein the rivet is secured a frame plate of the vehicle door latch assembly.

13. The method as in claim 12, wherein the rivet further comprises a shaft portion and a head member, the head member being disposed over the engagement surface of the detent lever and the engagement surface of the forkbolt.

14. The method as in claim 9, wherein the anti-bypass member is a rivet secured to the vehicle door latch assembly, the rivet having a shaft portion and a head portion depending outwardly from the shaft portion.

15. The method as in claim 14, wherein the rivet is secured to a frame plate of the vehicle door latch assembly and the forkbolt and the detent lever are movably secured to the frame plate for pivotal movement in a first plane.

16. The method as in claim 15, wherein the head member is disposed in a second plane, the second plane being spaced from the first plane to allow for pivotal movement of the forkbolt and the detent lever and the head member is disposed over the engagement surface of the detent lever and the engagement surface of the forkbolt.

17. The method as in claim 16, wherein the first plane is parallel to the second plane.
